(19) United States
(12) Patent Application Publication
(10) Pub. No.: US 2007/0072106 A1
(43) Pub. Date: Mar. 29, 2007

(54) Method of preparing toner using reformed plant oil and toner prepared using the method

(75) Inventors: Chang-kook Hong, Suwon-si (KR); Kyung-yol Yon, Seongnam-si (KR); Jun-young Lee, Seoul (KR); Min-young Cheong, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/517,502

(22) Filed: Sep. 8, 2006

(30) Foreign Application Priority Data
Sep. 24, 2005 (KR) 10-2005-0089042

(51) Int. Cl. G03G 9/087

(52) U.S. Cl. 430/109.31; 430/137.15; 430/109.1; 430/109.3; 430/126

(57) ABSTRACT

A method of preparing a toner is provided, including: polymerizing a toner composition including a chemically reformed or modified plant oil or a fatty acid, one or more polymerizable monomers, and a colorant with a free radical initiator; and separating and drying the polymerized toner. Also, provided are a toner prepared using the method, an image forming process using the toner, and an image forming apparatus employing the toner. According to the method, an environmentally friendly toner with superior durability and fixation properties is manufactured by using chemically reformed or modified plant oil or fatty acid. Also, regulating the size, the distribution and the configuration of toner particles are easy. In addition, the method does not involve the use or minimizes the use of a surfactant, thus decreasing the amounts of polluted water and waste water, which is very advantageous environmentally.

### CROSS-REFERENCE TO RELATED PATENT APPLICATION

This application claims the benefit of Korean Patent Application No. 10-2005-0089042, filed on Sep. 24, 2005, in the Korean Intellectual Property Office, the disclosure of which is hereby incorporated by reference in its entirety.

### BACKGROUND OF THE INVENTION

1. Field of the Invention

The present invention relates to a method of preparing a toner and to the toner prepared by the method. More particularly, the invention is directed to a method of preparing a toner using reformed or modified plant oil or fatty acid, and to the toner prepared by the method. The invention is further directed to an image forming process using the toner, and an image forming apparatus using the toner.

2. Description of the Related Art

In an electrophotographic process or an electrostatic recording process, a developer is used to form an electrostatic image or an electrostatic latent image. The developer may be a two-component developer formed of a toner and carrier particles or a one-component developer formed of a toner only, without carrier particles. The one-component developer may be a magnetic one-component developer having magnetic properties or a nonmagnetic one-component developer not having magnetic properties. Plasticizers such as colloidal silica are often added independently into the nonmagnetic one-component developer to increase the flowability of the toner. Generally, coloring particles obtained by dispersing a colorant, such as carbon black, or other additives in a binding resin are used in the toner.

Methods of preparing toners include a process step of pulverization or polymerization. In the pulverization process, the toner is obtained by melt mixing synthetic resins with colorants and, if needed, other additives, pulverizing the mixture and classifying the particles until a desired size of particles is obtained. In the polymerization process, a polymerizable monomer composition is manufactured by uniformly dissolving or dispersing a polymerizable monomer, a colorant, a polymerization initiator and, if needed, various additives such as a cross-linking agent and an antistatic agent. Next, the polymerizable monomer composition is dispersed in an aqueous dispersive medium which includes a dispersion stabilizer using an agitator to form minute liquid drop particles. Subsequently, the temperature is increased and suspension polymerization is performed to obtain a polymerized toner having coloring polymer particles of a desired size.

An image forming apparatus such as an electrophotographic apparatus or an electrostatic recording apparatus forms an electrostatic latent image through light-exposure on the surface of a photoreceptor which is uniformly charged. A toner is attached to the electrostatic latent image, and a resulting toner image is transferred to a transfer medium such as a paper through several processes such as heating, pressing, solvent steaming, etc. In most fixing processes, the transfer medium with the toner image passes through fixing rollers and pressing rollers, and the toner image is fused to the transfer medium by the heat and pressure.

Improvements in preciseness and minuteness are required for images formed by an image forming apparatus such as an electrophotocopier. Conventionally, a toner used in an image forming apparatus is usually obtained using a pulverization process step. When using a pulverization process step, it is likely to form coloring particles with a wide range of particle sizes. Hence, to obtain satisfactory developer properties, there is a need to classify the coloring particles obtained by the pulverization process according to size to obtain a narrow particle size distribution. However, it is difficult to precisely control the particle size distribution using a conventional mixing/pulverizing process in the manufacture of toner particles suitable for an electrophotographic process or electrostatic recording process. Also when preparing a minute particle toner, a toner preparation yield is low as a result of the classification process. In addition, there is a limit to a change/adjustment of a toner design for obtaining desirable charging and fixing properties. Accordingly, polymerized toners, in which the size of particles is easy to control and which do not need to go through a complex manufacturing process such as classification, have recently become of interest.

When a toner is prepared using polymerization, the desired size distribution of particles is obtained without performing pulverization or classification.

U.S. Pat. No. 5,247,034 to, Mate et al. discloses a process for preparing a toner by (1) emulsion copolymerizing a vinyl aromatic monomer and a second monomer selected from the group consisting of conjugated diene monomers and an acrylate monomer selected from the group consisting of alkyl acrylate monomers and methacrylate monomers in the presence of an amino acid soap to produce the polymer; and (2) recovering the polymer from the aqueous emulsion. The process uses an acrylate monomer, which is disadvantageous environmentally.

U.S. Pat. No. 5,852,151 to Burroway et al. discloses a process for preparing a polymer useful as a toner resin, which comprises (1) emulsion copolymerizing a vinyl aromatic monomer and a second monomer selected from the group consisting of conjugated diene monomers and acrylate monomers selected from the group consisting of alkyl acrylate monomers and alkyl methacrylate monomers in the presence of a diacid cycloaliphatic emulsifier to produce the toner resin; and (2) recovering the toner resin from the aqueous emulsion. The process uses conventional emulsifying agent, which is disadvantageous environmentally.

### SUMMARY OF THE INVENTION

The present invention provides a method of preparing a toner, which is environmentally friendly, has superior properties in particle size control, storage property, and durability, and is prepared easily.

The present invention also provides a toner which is environmentally friendly and has superior properties in particle size control, storage property, and durability.

The present invention also provides an image forming method in which a high quality image can be fused at a low temperature by using a toner which is environmentally friendly and has superior properties in particle size control, storage property, and durability.

The present invention also provides an image forming apparatus in which a high quality image can be fused at a low temperature by using a toner which is environmentally friendly and has superior properties in particle size control, storage property, and durability.

According to an aspect of the present invention, a method of preparing a toner is provided, including: polymerizing the toner by reacting a toner composition including a chemically reformed or modified plant oil or a fatty acid, one or more polymerizable monomer, and a colorant with a free radical initiator; and separating and drying the polymerized toner.

According to another aspect of the present invention, a toner is manufactured by polymerizing a toner composition including a chemically reformed or modified plant oil or a fatty acid, one or more polymerizable monomers, and a colorant with a free radical initiator, and separating and drying the polymerized toner.

According to another aspect of the present invention, an image forming method is provided including: forming a visible image by depositing a toner on an photoreceptor surface having an electrostatic latent image formed thereon; and transferring the visible image to a transfer medium wherein the toner is manufactured by polymerizing the toner by reacting a toner composition including a chemically reformed plant oil or a fatty acid, one or more polymerizable monomers, and a colorant with a free radical initiator, and separating and drying the polymerized toner.

According to another aspect of the present invention, an image forming apparatus is provided including: an organic photoreceptor; a unit for electrifying a surface of the organic photoreceptor; a unit for containing a toner manufactured by polymerizing the toner by reacting a toner composition including a chemically reformed plant oil or a fatty acid, one or more polymerizable monomers, and a colorant with a free radical initiator, and separating and drying the polymerized toner; a unit for supplying the toner to the surface of the organic photoreceptor to develop an electrostatic latent image on the surface of the organic photoreceptor into a toner image; and a unit for transferring the toner image on the surface of the organic photoreceptor to a transfer medium.

According to the present invention, an environmentally friendly toner with high fixability, storability, and durability can be prepared.

These and other aspects of the invention will become apparent from the following detailed description of the invention which, taken in conjunction with the annexed drawings, disclose various embodiments of the invention.

### BRIEF DESCRIPTION OF THE DRAWING

The above and other features and advantages of the present invention will become more apparent by describing in detail exemplary embodiments thereof with reference to the attached drawing in which:

FIG. 1 is a schematic diagram of an image forming apparatus employing a toner prepared using a method according to an embodiment of the present invention.

### DETAILED DESCRIPTION OF THE INVENTION

The present invention provides a method of preparing a toner, including: polymerizing toner composition by reacting the toner composition including a chemically reformed plant oil or a fatty acid, one or more polymerizable monomers, and a colorant with a free radical initiator; and separating and drying the resulting polymerized toner. In embodiments of the invention, the toner composition comprises a modified triglyceride or carboxylic acid having a polymerizable reactive group.

The reformed and modified plant oil may generally be bean oil, the main ingredient of which are triglycerides. The triglycerides have a form of three fatty acids bonded to the connecting points of glycerol. Triglycerides are the main components of many vegetable and animal oils.

The fatty acid groups of the triglyceride, carboxylic acid, or the fatty acids may include 4 to 22 carbon atoms and 0 to 6 double bonds. The fatty acid groups may be saturated fatty acids or unsaturated fatty acids.

The saturated fatty acids may be formed of, although are not limited to, one or more acids selected from the group consisting of propionic acid, butyric acid, valeric acid, caproic acid, enantate, caprylic acid, pelargonic acid, capric acid, undecylic acid, lauric acid, tridecylic acid, myristic acid, pentadecylic acid, palmitic acid, heptadecylic acid, stearic acid, nonadecanoic acid, arachic acid, behenic acid, lignoceric acid, cerotic acid, heptacosanoic acid, montanic acid, melissic acid, and lacceric acid. Typically, these saturated acids are the acid groups of a triglyceride.

The unsaturated fatty acid may be formed of, although is not limited to, one or more acids selected from the group consisting of crotonic acid, isocrotonic acid, undecylenic acid, oleic acid, elaidic acid, cetoleic acid, erucic acid, brassidic acid, sorbic acid, linoleic acid, linolenic acid, arachidonic acid, propiolic acid, and stearolic acid. These unsaturated acids are also typically the acid groups of the triglyceride.

Chemically unreformed triglyceride or fatty acid does not participate in a polymerization reaction or easily polymerize. By the chemical reformation or modification, functional groups can be added easily, generating a polymerizable triglyceride to enable the polymerization reaction to proceed easily.

The chemical reforming process may be, although is not limited to, an acrylate conversion process, an epoxy conversion process or a maleate conversion process. In embodiments of the invention, the triglyceride and/or fatty acid are modified to include at least one functional group selected from the group consisting of an acrylate, epoxide, maleate, and mixtures thereof. The reformed and modified fatty acid may substitute a petrochemical-based monomer obtained from petroleum normally used in toner preparing process. An environmentally friendly resin obtained using the reformed fatty acid increases the adhesive strength of the toner to paper and increases the durability by cross-linking during the polymerization reaction. The degree of cross-linking may be regulated during the toner preparation reaction and the cross-linking of the surface of the toner increases the durability and storability of the toner, which is advantageous in preparing a toner having high fixability at a low temperature. The chemically modified triglyceride or fatty acid is modified so that the fatty acid or the at least one of the fatty acid chains of the triglyceride contain at least one reactive function group capable of reacting with the polymerizable monomer.

The polymerizable monomer may be formed of, although is not limited to, one or more materials selected from the group consisting of styrene-based monomer such as styrene, vinyltoluene, and a-methylstyrene; acrylic acid and methacrylic acid; (meth)acrylic acid derivative such as methylacrylate, ethylacrylate, propylacrylate, butylacrylate, 2-ethlyhexylacrylate, dimethylaminoethylacrylate, methylmethacrylate, ethylmethacrylate, propylmethacrylate, butylmethacrylate, 2-ethylhexylmethacrylate, dimethylaminoethylmethacrylate; a (meth)acrylic acid derivative of amide selected from the group consisting of acrylonitrile, methacrylonitrile, acrylamide and methacrylamide; ethylenically unsaturated monoolefin such as ethylene, propylene and butylene; halogenated vinyl such as vinyl chloride, vinylidene chloride and vinyl fluoride; vinyl ester such as vinyl acetate and vinyl propionate; vinyl ether such as vinyl methyl ether and vinyl ethyl ether; vinyl ketone such as vinyl methyl ketone and methyl isopropenyl ketone; and vinyl compounds having a nitrogen such as 2-vinyl pyridine, 4-vinyl pyridine and N-vinyl pyrrolidone.

The amount of the polymerizable monomer is in the range of 3 to 50 parts by weight based on 100 parts by weight of the toner composition. When the amount of the polymerizable monomer is less than 3 parts by weight based on 100 parts by weight of the toner composition, the yield is low. When the amount of the polymerizable monomer exceeds 50 parts by weight based on 100 parts by weight of the toner composition, the stability of the toner composition is low.

The medium used in the present invention may be an aqueous solution or a mixture of water and an organic solvent.

By using a macromonomer instead of a conventional emulsifying agent or a dispersing agent, a preparing process or a cleaning process can be simplified and the storage stability of a toner can be increased.

The macromonomer according to the present invention is an amphipathic material having both a hydrophilic group and a hydrophobic group, and a polymer or an oligomer having at least one reactive functional group. The hydrophilic group reacts with a medium which improves the water dispersion of the monomer, and the hydrophobic group promotes the emulsion polymerization by adhering to the surface of toner particles. The macromonomer can form a copolymer by binding with a polymerizable monomer in the toner composition in various ways, such as grafting, branching or cross-linking. By using the macromonomer according to an embodiment of the present invention, the durability and anti-offset of toner particles can be improved. Also, the macromonomer can act as a stabilizer by forming stabilized micelles during the emulsion polymerization.

The weight average molecular weight of the macromonomer is in the range of 100 to 100,000, and preferably in the range of 1,000 to 10,000. When the weight average molecular weight of the macromonomer is less than 100, the properties of the toner may not be improved or the macromonomer may not operate properly as a stabilizer. Also, when the weight average molecular weight of the macromonomer is greater than 100,000, a reaction conversion rate may be low.

The macromonomer may be, for example, a material selected from the group consisting of polyethylene glycol (PEG)-methacrylate, PEG-ethyl ether methacrylate, PEG-dimethacrylate, PEG-modified urethane, PEG-modified polyester, polyacrylamide (PAM), PEG-hydroxyethyl methacrylate, hexafunctional polyester acrylate, dendritic polyester acrylate , carboxy polyester acrylate, fatty acid modified epoxy acrylate and polyester methacrylate, but is not limited thereto.

The amount of the macromonomer may be in the range of 1 to 50 parts by weight based on 100 parts by weight of the toner composition. When the amount of the macromonomer is less than 1 part by weight based on 100 parts by weight of the toner composition, the stability of the particle distribution is low, and when the amount of the macromonomer exceeds 50 parts by weight based on 100 parts by weight of the toner composition, the property of the toner deteriorates.

Radicals in the toner composition are formed by the initiator, and the radical may react with the polymerizable monomer. The radical reacts with the polymerizable monomer and the reactive functional group of the macromonomer to form a copolymer.

Examples of the radical polymerized initiator include persulfates, such as potassium persulfate, ammonium persulfate, etc.; azo compounds, such as 4,4-azobis (4-cyanovaleric acid), dimethyl-2,2′-azobis (2-methylpropionate), 2,2-azobis (2-amidinopropane) dihydrochloride, 2,2-azobis-2-methyl-N-1,1-bis (hydroxymethyl)-2-hydroxyethylpropionamide, 2,2′-azobis (2,4-dimethylvaleronitrile), 2,2′-azobisisobutyronitrile, 1,1′-azobis (1-cyclohexanecarbonitrile), etc.; peroxides, such as methylethylperoxide, di-t-butylperoxide, acetylperoxide, dicumylperoxide, lauroylperoxide, benzoylperoxide, t-butylperoxide-2-ethylhexanoate, di-isopropylperoxydicarbonate, di-t-butylperoxyisophthalate, etc. Also, an oxidation-reduction initiator may be used, which is a combination of a polymerized initiator and a reducing agent.

A developer according to an embodiment of the present invention may include a colorant. The colorant may be carbon black or aniline black in the case of a black toner. Also, it is easy to produce a color toner with a nonmagnetic toner according to an embodiment of the present invention. In the case of a color toner, carbon black is used as a colorant for black, and a yellow colorant, a magenta colorant and a cyan colorant are further included as colorants for the colors.

The yellow colorant may be a condensed nitrogen compound, an isoindolinone compound, an anthraquinone compound, an azo metal complex, or an aryl imide compound. Examples include C.I. pigment yellow 12, 13, 14, 17, 62, 74, 83, 93, 94, 95, 109, 110, 111, 128, 129, 147, 168, 180, etc.

The magenta colorant may be a condensed nitrogen compound, anthraquinone, a quinacridone compound, a lake pigment of basic dye, a naphthol compound, a benzoimidazole compound, a thioindigo compound, or a perylene compound. Examples include C.I. pigment red 2, 3, 5, 6, 7, 23, 48:2, 48:3, 48:4, 57:1, 81:1, 122, 144, 146, 166, 169, 177, 184, 185, 202, 206, 220, 221, 254, etc.

The cyan colorant may be a copper phthalocyanine compound or a derivative thereof, an anthraquinone compound, or a lake pigment of a basic dye. Examples include C.I. pigment blue 1, 7, 15, 15:1, 15:2, 15:3, 15:4, 60, 62, 66, etc.

These colorants may be used alone or in combinations of two or more types. A desired colorant is selected considering the desired color, saturation, brightness, weatherability, and dispersability in a toner.

The amount of the colorant may be in the range of 0.1 to 20 parts by weight based on the 100 parts by weight of a polymerizable monomer. The amount of the colorant is not particularly limited as long as it is sufficient to color the toner. When the amount of the colorant is less than 0.1 parts by weight, the coloring is insufficient. When the amount of the colorant exceeds 20 parts by weight, the production costs of the toner increase and the toner is unable to obtain enough triboelectric charge.

The toner composition may further include at least one material selected from the group consisting of wax, a charge control agent and a release agent.

The release agent protects a photoreceptor and prevents deterioration of developing properties, and thus may be used for the purpose of obtaining a high quality image. A release agent according to an embodiment of the present invention may use a solid fatty acid ester material with high purity. In detail, a low molecular weight polyolefin, such as low molecular weight polyethylene, low molecular weight polypropylene, low molecular weight polybutylene, etc.; paraffin wax; or a multifunctional ester compound, etc. may be used. The release agent may be a multifunctional ester compound formed of an alcohol having at least three functional groups and carboxylic acid.

The polyhydric alcohol with at least three functional groups may be an aliphatic alcohol, such as glycerin, pentaerythritol, pentaglycerol, etc.; an alicyclic alcohol, such as chloroglycitol, quersitol, inositol, etc.; an aromatic alcohol, such as tris (hydroxymethyl) benzene, etc.; a sugar, such as D-erythrose, L-arabinose, D-mannose, D-galactose, D-fructose, sucrose, maltose, lactose, etc.; or a sugar-alcohol, such as erythrite, etc.

The carboxylic acid may be an aliphatic carboxylic acid, such as acetic acid, butyric acid, caproic acid, enantate, caprylic acid, pelargonic acid, capric acid, undecanoic acid, lauric acid, myristic acid, stearic acid, magaric acid, arachidic acid, cerotic acid, sorbic acid, linoleic acid, linolenic acid, behenic acid, tetrolic acid, etc.; an alicyclic carboxylic acid, such as cyclohexanecarboxylic acid, hexahydroisophthalic acid, hexahydroterephthalic acid, 3,4,5,6-tetrahydrophthalic acid, etc.; or an aromatic carboxylic acid, such as benzoic acid, cumic acid, phthalic acid, isophthalic acid, terephthalic acid, trimeth acid, trimellitic acid, hemimellitic acid, etc.

The charge control agent may be formed of a material selected from the group consisting of a salicylic acid compound containing a metal, such as zinc or aluminum, a boron complex of bisdiphenylglycolic acid, and silicate. More particularly, dialkyl salicylic acid zinc or borobis (1,1-diphenyl-1-oxo-acetyl potassium salt) may be used.

A suitable wax which provides a desired characteristic of the final toner compound may be used. The wax may be polyethylene wax, polypropylene wax, silicon wax, paraffin wax, ester wax, carnauba wax or metallocene wax, but is not limited thereto. The melting point of the wax may be in the range of about 50 to about 150° C. Wax components physically adhere to the toner particles, but do not covalently bond with the toner particles. The toner fixes to a final image receptor at a low fixation temperature and has superior final image durability and antiabrasion property.

The method of preparing the toner according to the present invention will now be described in detail.

While purging a reactor with nitrogen gas, a colorant dispersion is injected into the reactor and water or a mixture of water and a solvent is added thereto, and the resultant is mixed. At this time, an electrolyte such as NaCl or ionic salt can be added to control the ionic strength of a reaction medium. When the temperature inside the reactor reaches an appropriate value, an initiator, such as a water soluble free radical initiator, is injected. Subsequently, a polymerizable monomer, a colorant, and a reformed or modified plant oil or at least one unsaturated reactive monomer in a fatty acid are injected into the reactor semicontinuously and selectively with a dispersion of wax, a chain transfer agent, and a macromonomer. To control the reaction rate and the degree of dispersion, before injecting the initiator, the macromonomer can be dispersed in the medium inside the reactor beforehand.

In the present invention, an environmentally friendly toner with high durability and fixability can be prepared by using chemically reformed plant oil or a fatty acid. An environmentally friendly green toner may be produced using a triglyceride or a fatty acid obtained from environmentally friendly oil and reducing the use of an acrylic acid or an acrylate obtained from petroleum.

The emulsion polymerization according to the present invention does not involve the use of a conventional emulsifying agent, so that a cleaning process is not required during separation and filtration processes of the toner particles prepared after the reaction, or a use of emulsifying agents is minimized. By minimizing the cleaning process, the preparing process is simplified and the production costs can be reduced. Also, the amounts of polluted water and waste water can be reduced, which is very advantageous environmentally. In addition, by not using or minimizing the use of the emulsifying agent, problems such as sensitivity at high humidity, low friction electric charge, decrease of induced electricity and weak toner flow can be limited, and the storage stability of the toner can be improved remarkably.

The polymerizing reaction may be performed for 3 to 12 hours depending on the reaction temperature. Particles obtained as a product of the reaction are filtered, separated and dried. At this time, an agglomeration process may be performed to control the particle size. An additive may be further added to the dried toner for use in an image forming apparatus, preferably in a laser printer.

The present invention also provides a toner manufactured by polymerizing the toner using a reaction of a toner composition including a chemically reformed or modified plant oil or a fatty acid, one or more polymerizable monomers, and a colorant with a free radical initiator, and separating and drying the polymerized toner.

The reformed or modified plant oil may be produced from a triglyceride. The fatty acid component of the triglyceride and/or the fatty acid per se typically has 4 to 22 carbon atoms and 0 to 6 double bonds. The fatty acid is selected from the group consisting of a saturated fatty acid or an unsaturated fatty acid. The average volumetric particle size of the obtained toner particles may be in the range of 0.5 to 20 μm, and preferably in the range of 5 to 10 μm. The fatty acid or triglyceride is modified to include at least one reactive group.

The toner of the present invention may be prepared by further including a macromonomer having hydrophilic group, hydrophobic group, and at least one reactive functional group. Also, the toner composition may further include one or more materials selected from the group consisting of wax, a charge control, agent and a release agent, the details of which are explained above.

The present invention also provides an image forming method including: forming a visible image by depositing a toner on an photoreceptor surface having an electrostatic latent image; and transferring the visible image to a transfer medium. The toner is manufactured by polymerizing a toner composition including a chemically reformed or modified plant oil or a fatty acid, one or more polymerizable monomers, and a colorant with a free radical initiator, and separating and drying the polymerized toner.

An electrophotographic image forming process includes a charging process, a light-exposing process, a developing process, a transferring process, a fusing process, a cleaning process and an erasing process, which are a series of processes to form an image on an image receptor.

In the charging process, the photoreceptor is covered with electric charges of desired polarity, either negative or positive, by a corona or a charging roller. In the light-exposing process, an optical system, generally a laser scanner or an array of diodes, forms a latent image corresponding to a final visual image to be formed on an image receptor by selectively discharging the charging surface of the photoreceptor in an imagewise manner. Electromagnetic radiation (hereinafter, “light”) may include infrared radiation, visible rays and ultraviolet radiation.

In the developing process, in general, the toner particles with suitable polarity contact the latent image on the photoreceptor, and typically, an electrically biased developer which has a potential with the same polarity as the toner is used. The toner particles move to the photoreceptor, selectively adhere to the latent image through static electricity and form a toner image on the photoreceptor.

In the transferring process, the toner image is transferred from the photoreceptor to a desired final image receptor. Sometimes an intermediate transferring element is used to effect the transfer of the tone image from the photoreceptor to the final image receptor.

In the fusing process, the toner image is fused to the final image receptor by melting or softening the toner particles by heating the toner image on the final image receptor. Alternatively, the toner can be fused to the final image receptor under high pressure while being heated or without heating. In the cleaning process, the toner particles remaining on the photoreceptor are removed. In the erasing process, an electric charge on the photoreceptor is exposed to light of a certain wavelength, and the electric charge is substantially decreased to a uniform low value. Consequentially, a residue of the latent image is removed and the photoreceptor is prepared for the next image forming cycle.

The present invention also provides an image forming apparatus including: an organic photoreceptor; a unit for electrifying a surface of the organic photoreceptor; a unit for containing a toner manufactured by polymerizing the toner using a reaction of a toner composition including a chemically reformed or modified plant oil or a fatty acid, one or more polymerizable monomers, and a colorant with a free radical initiator, and separating and drying the polymerized toner; a unit for supplying the toner to the surface of the organic photoreceptor to develop an electrostatic latent image on the surface of the organic photoreceptor into a toner image; and a unit for transferring the toner image on the surface of the organic photoreceptor to a transfer medium.

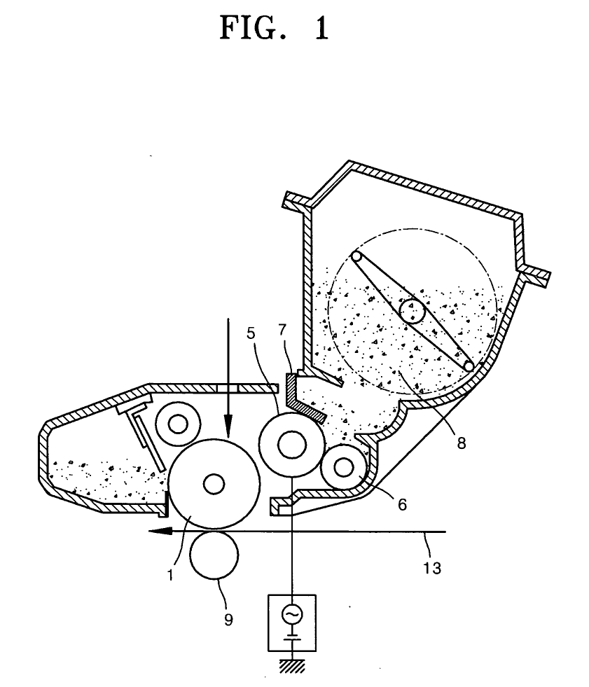

FIG. 1 is a schematic diagram of a non-contact developing type image forming apparatus using a toner prepared using the method according to an embodiment of the present invention. The operating principles of the image forming apparatus are explained below.

A developer 8, which is a nonmagnetic one-component developer, is supplied to a developing roller 5 through a feeding roller 6 formed of an elastic material such as polyurethane form and sponge. The developer 8 supplied to the developing roller 5 reaches a contact point between the developing roller 5 and a developer regulation blade 7 as the developing roller 5 rotates. The developer regulation blade 7 is formed of an elastic material such as metal, rubber, etc. When the developer 8 passes the contact point between the developing roller 5 and the developer regulation blade 7, the developer 8 is smoothed to form a thin layer and the developer 8 is sufficiently charged. The developing roller 5 transfers the thin layer of the developer 8 to a developing domain where the developer 8 is developed on the electrostatic latent image of a photoreceptor 1, which is a latent image carrier.

The developing roller 5 and the photoreceptor 1 face each other with a constant distance therebetween without contact. The developing roller 5 rotates counterclockwise and the photoreceptor 1 rotates clockwise. The developer 8 transferred to the developing domain forms an electrostatic latent image on the photoreceptor 1 according to the intensity of an electric charge generated due to a difference between a voltage applied to the developing roller 5 and a latent image potential of the photoreceptor 1.

The developer 8 developed on the photoreceptor 1 reaches a transferring device 9 as the photoreceptor 1 rotates. The developer 8 developed on the photoreceptor 1 is transferred through corona discharging or by a roller to a printing paper 13 as the printing paper 13 passes between the photoreceptor 1 and the transferring device 9 by the transferring device 9 to which a high voltage with an opposite polarity to the developer 8 is applied, and thus forms an image.

The image transferred to the printing paper 13 passes through a fusing device (not shown) that provides high temperature and high pressure to fuse the image to the printing paper 13. Any remaining developer 8 on the developing roller 5 which is not developed is taken back by the feeding roller 6 contacting the developing roller 5. The above processes are repeated.

The present invention will now be described in greater detail with reference to the following examples. The following examples are for illustrative purposes only and are not intended to limit the scope of the invention.

### EXAMPLES

### Example 1

630 g of deionized water was injected into a reactor while continuously purging inside the reactor with nitrogen gas, and then was heated while stirring at 300 RPM. When the temperature inside the reactor reached 80° C., 2.8 g of potassium persulfate was injected as an initiator, and 200 g of a monomer compound of styrene, n-butyl acrylate, and acrylated epoxidized fatty acid (available from Miwon Co.) at the rate of 7:2:1 was added semicontinuously into the reactor with 2.5 g of a chain transfer agent, 1-dodecanethiol. During the reaction, 30 g of dispersion of PB 15:3 of cyan pigment was added as a colorant with 8 g of dispersion of wax. A colorant dispersion was prepared by mixing it with the monomer compound and then dispersing thereof in a dispersing mixer (Dispermat Milling) at 5000 RPM for about an hour. The reaction time was 8 hours, and after the reaction, the resultant was stirred and cooled naturally. After cooling, 10 g of NaCl was added after dissolving in 40 g of deionized water and heated until 95° C. When the average volumetric particle size of the particles manufactured reached 6.5 μm, the particles were cooled to obtain the toner particles.

### Example 2

The process of Example 1 was repeated except that acrylated epoxidized soybean oil was used instead of fatty acid reformed epoxy acrylate. When the average volumetric particle size of the particles manufactured reached 6.5 μm, the particles were cooled to obtain the toner particles.

Example 3

The process of Example 1 was repeated except that polyethylene glycol methacrylate (PEG-MA) was introduced with deionized water during the early stage of the reaction. The reaction time was 8 hours and when the average volumetric particle size of the particles manufactured reached about 6.9 μm, the particles were cooled to obtain the toner particles. The number average particle size was about 6.7 μm.

### Example 4

The process of Example 3 was repeated except that PEG-ethyl ether methacrylate (EEMA) was used instead of PEG-MA. Also, instead of ester wax, 8 g of polyethylene wax was used. When the average volumetric particle size of the particles manufactured reached 6.3 μm, they were cooled to obtain the toner particles. The number average size was 6.1 μm.

### Comparative Example

Conventional Emulsion/Aggregation Process

Preparation of Latex

0.5 g of sodium dodecyl sulfate (SDS) as an anionic surfactant, was mixed in 400 g of ultra-high pure water that was deoxidized. The aqueous solution was introduced into a reactor and heated to 80° C. When the temperature reached 80° C., an initiator, which was a solution of 0.2 g of potassium persulfate in 30 g of ultra-high pure water, was added. After 10 minutes, 105.5 g of styrene, butylacrylate and methacrylic acid (each 81 g, 22 g, 2.5 g respectively) were dropwise added for about 30 minutes. After allowing a reaction to occur for 4 hours, the heating was stopped and the product was allowed to cool naturally. 30 g of the resultant seed solution was removed and added to 351 g of ultra-high pure water, and the result was heated to 80° C. 17 g of ester wax was heated and dissolved together with 18 g of monomer styrene, 7 g of butylacrylate, 1.3 g of methacrylic acid, and 0.4 g of dodecanethiol. The prepared wax/mixed monomer was added to 220 g of ultra-high pure water in which 1 g of SDS was dissolved, and the result was homogenized for about 10 minutes in an ultrasonic homogenizer. The homogenized emulsified solution was introduced into the reactor and after about 15 minutes, 5 g of the initiator and 40 g of ultra-high pure water were mixed and added to the reactor. During this time, the reaction temperature was maintained at 82° C. and the reaction was allowed to continue thereafter for about 2 hours and 30 minutes. After the reaction was performed for 2 hours and 30 minutes, 1.5 g of the initiator and 60 g of ultra-high pure water were again added together with a monomer for shell layer formation. The monomer was composed of 56 g of styrene, 20 g of butylacrylate, 4.5 g of methacrylic acid, and 3 g of dodecanethiol. The monomer was dropwise added to the reactor for about 80 minutes. After the reaction was performed for two hours, the reaction was stopped and the product was allowed to cool naturally.

Toner Aggregation/Melting Process

318 g of latex particles prepared as described above were mixed with ultra-high pure water in which 0.5 g of an SDS emulsifier was dissolved. 18.2 g of pigment particles (cyan 15:3, 40 solidity %) dispersed by the SDS emulsifier were added to obtain a latex pigment dispersed aqueous solution. While stirring at 250 RPM, the pH of the latex pigment dispersed aqueous solution was titrated to pH 10 using a 10% NaOH buffer solution. 30 g of ultra-high pure water was dissolved in 10 g of MgCl₂ as an aggregating agent, and the result was dropwise added to the latex pigment aqueous solution for about 10 minutes. The temperature of the result was increased to 95° C. at a rate of 1° C./min. After about 3 hours of heating, the reaction was stopped and the product was allowed to cool naturally. The average volumetric particle size was about 6.5 μm and Tg was 53.5° C.

The present invention has the following advantages.

First, a toner which is environmentally friendly and has high durability and fixability is prepared by using chemically reformed plant oil or a fatty acid.

Second, a cleaning process is simplified and a storability of the toner is improved by using a macromonomer instead of a conventional emulsifying agent. Also, generation of polluted water and waste water is decreased, which is very advantageous environmentally. In addition, the toner preparation process is simplified, which reduces production costs.

Third, the anti-offset, friction electric charge property, and storage stability of the toner are high, which allows printing of high quality images. Also, a polymerized toner with superior properties can be prepared under a high density environment.

Fourth, by regulating chemical reformation property of a fatty acid, fusing of the toner to paper is improved and regulation and controlling of toner particles are easy.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of preparing a toner, comprising:
polymerizing a toner composition comprising a chemically reformed or modified plant oil or a fatty acid, one or more polymerizable monomers, and a colorant with a free radical initiator to form a toner; and
separating and drying the polymerized toner.

2. The method of claim 1, wherein the reformed or modified plant oil is produced from a triglyceride.

3. The method of claim 1, wherein said reformed and modified plant oil or fatty acid is acrylate modified, epoxy modified or maleate modified triglyceride or fatty acid.

4. The method of claim 1, wherein the fatty acid has 4 to 22 carbon atoms and 0 to 6 double bonds and is at least one selected from the group consisting of a saturated fatty acid and an unsaturated fatty acid.

5. The method of claim 4, wherein the saturated fatty acid is one or more selected from the group consisting of propionic acid, butyric acid, valeric acid, caproic acid, enantate, caprylic acid, pelargonic acid, capric acid, undecylic acid, lauric acid, tridecylic acid, myristic acid, pentadecylic acid, palmitic acid, heptadecylic acid, stearic acid, nonadecanoic acid, arachic acid, behenic acid, lignoceric acid, cerotic acid, heptacosanoic acid, montanic acid, melissic acid, and lacceric acid.

6. The method of claim 4, wherein the unsaturated fatty acid is one or more selected from the group consisting of crotonic acid, isocrotonic acid, undecylenic acid, oleic acid, elaidic acid, cetoleic acid, erucic acid, brassidic acid, sorbic acid, linoleic acid, linolenic acid, arachidonic acid, propiolic acid, and stearolic acid.

7. The method of claim 1, wherein the chemical reforming process comprises a conversion process selected from the group consisting of acrylate conversion, epoxy conversion, and maleate conversion of a triglyceride or fatty acid.

8. The method of claim 1, wherein the polymerizable monomer comprises at least one material selected from the group consisting of a styrene-based monomer selected from the group consisting of styrene, vinyltoluene, and α-methylstyrene; acrylic acid; methacrylic acid; a (meth)acrylic acid derivative selected from the group consisting of methylacrylate, ethylacrylate, propylacrylate, butylacrylate, 2-ethlyhexylacrylate, dimethylaminoethylacrylate, methylmethacrylate, ethylmethacrylate, propylmethacrylate, butylmethacrylate, 2-ethylhexylmethacrylate, and dimethylaminoethylmethacrylate; a (meth)acrylic acid derivative of amide selected from the group consisting of acrylonitrile, methacrylonitrile, acrylamide and methacrylamide; an ethylenically unsaturated monoolefin selected from the group consisting of ethylene, propylene and butylene; a halogenated vinyl selected from the group consisting of vinyl chloride, vinylidene chloride and vinyl fluoride; a vinyl ester selected from the group consisting of vinyl acetate and vinyl propionate; a vinyl ether selected from the group consisting of vinyl methyl ether and vinyl ethyl ether; a vinyl ketone selected from the group consisting of vinyl methyl ketone and methyl isopropenyl ketone; and a vinyl compound having nitrogen selected from the group consisting of 2-vinyl pyridine, 4-vinyl pyridine and N-vinyl pyrrolidone.

9. The method of claim 1, wherein the amount of the polymerizable monomer is in the range of 3 to 50 parts by weight based on 100 parts by weight of the toner composition.

10. The method of claim 1, wherein the colorant comprises at least one material selected from the group consisting of yellow, magenta, cyan, and black pigments.

11. The method of claim 1, wherein the amount of the colorant is in the range of 0.1 to 20 parts by weight based on 100 parts by weight of the toner composition.

12. The method of claim 1, wherein the toner composition further comprises a macromonomer having hydrophilic group, hydrophobic group, and at least one reactive functional group.

13. The method of claim 12, wherein the macromonomer is formed of a material selected from the group consisting of polyethylene glycol (PEG)-methacrylate, PEG-ethyl ether methacrylate, PEG-dimethacrylate, PEG-modified urethane, PEG-modified polyester, polyacrylamide (PAM), PEG-hydroxyethyl methacrylate, hexafunctional polyester acrylate, dendritic polyester acrylate, carboxy polyester acrylate, fatty acid modified epoxy acrylate, and polyester methacrylate.

14. The method of claim 12, wherein the amount of the macromonomer is in the range of 1 to 50 parts by weight based on 100 parts by weight of the toner composition.

15. The method of claim 1, wherein the toner composition further comprises one or more materials selected from the group consisting of wax, a charge control agent and a release agent.

16. A toner obtained by polymerizing a toner composition comprising a chemically reformed or modified plant oil or a fatty acid, one or more polymerizable monomers, and a colorant with a free radical initiator, and separating and drying the polymerized toner.

17. The toner of claim 16, wherein the reformed plant oil is formed from a triglyceride, and the fatty acid or fatty acid group of the triglyceride comprises 4 to 22 carbon atoms and 0 to 6 double bonds and wherein said fatty acid group or fatty acid is a saturated fatty acid or an unsaturated fatty acid.

18. The toner of claim 16, wherein the average volumetric particle size of the toner particles is in the range of 0.5 to 20 μm.

19. The toner of claim 16, wherein the average volumetric particle size of the toner particles is in the range of 5 to 10 μm.

20. The toner of claim 16, wherein the toner composition further comprises a macromononer having hydrophilic group, hydrophobic group, and at least one reactive functional group.

21. The toner of claim 16, further comprising one or more materials selected from the group consisting of wax, a charge control agent, and a release agent.

21. The toner of claim 16, wherein the fatty acid is unsaturated and is one or more selected from the group consisting of propionic acid, butyric acid, valeric acid, caproic acid, enantate, caprylic acid, pelargonic acid, capric acid, undecylic acid, lauric acid, tridecylic acid, myristic acid, pentadecylic acid, palmitic acid, heptadecylic acid, stearic acid, nonadecanoic acid, arachic acid, behenic acid, lignoceric acid, cerotic acid, heptacosanoic acid, montanic acid, melissic acid, and lacceric acid.

22. The toner of claim 16, wherein the fatty acid is saturated and is one or more selected from the group consisting of crotonic acid, isocrotonic acid, undecylenic acid, oleic acid, elaidic acid, cetoleic acid, erucic acid, brassidic acid, sorbic acid, linoleic acid, linolenic acid, arachidonic acid, propiolic acid, and stearolic acid.

23. The toner of claim 16, wherein the plant oil is a triglyceride and where said triglyceride or fatty acid is an acrylate modified, epoxy modified or maleate modified triglyceride or fatty acid.

24. The toner of claim 16, wherein the polymerizable monomer comprises at least one material selected from the group consisting of a styrene-based monomer selected from the group consisting of styrene, vinyltoluene, and α-methylstyrene; acrylic acid; methacrylic acid; a (meth)acrylic acid derivative selected from the group consisting of methylacrylate, ethylacrylate, propylacrylate, butylacrylate, 2-ethlyhexylacrylate, dimethylaminoethylacrylate, methylmethacrylate, ethylmethacrylate, propylmethacrylate, butylmethacrylate, 2-ethylhexylmethacrylate, and dimethylaminoethylmethacrylate; a (meth)acrylic acid derivative of amide selected from the group consisting of acrylonitrile, methacrylonitrile, acrylamide and methacrylamide; an ethylenically unsaturated monoolefin selected from the group consisting of ethylene, propylene and butylene; a halogenated vinyl selected from the group consisting of vinyl chloride, vinylidene chloride and vinyl fluoride; a vinyl ester selected from the group consisting of vinyl acetate and vinyl propionate; a vinyl ether selected from the group consisting of vinyl methyl ether and vinyl ethyl ether; a vinyl ketone selected from the group consisting of vinyl methyl ketone and methyl isopropenyl ketone; and a vinyl compound having nitrogen selected from the group consisting of 2-vinyl pyridine, 4-vinyl pyridine and N-vinyl pyrrolidone.

25. The toner of claim 20, wherein the macromonomer is formed of a material selected from the group consisting of polyethylene glycol (PEG)-methacrylate, PEG-ethyl ether methacrylate, PEG-dimethacrylate, PEG-modified urethane, PEG-modified polyester, polyacrylamide (PAM), PEG-hydroxyethyl methacrylate, hexafunctional polyester acrylate, dendritic polyester acrylate, carboxy polyester acrylate, fatty acid modified epoxy acrylate, and polyester methacrylate.

26. An image forming method comprising:
forming a visible image by depositing the toner of claim 16 on an photoreceptor surface having an electrostatic latent image formed thereon; and
transferring the visible image to a transfer medium.

27. An image forming apparatus comprising:
an organic photoreceptor;
a unit for electrifying a surface of the organic photoreceptor;
a unit for containing the toner of claim 16;
a unit for supplying the toner to the surface of the organic photoreceptor to develop an electrostatic latent image on the surface of the organic photoreceptor into a toner image; and
a unit for transferring the toner image on the surface of the organic photoreceptor to a transfer medium.
